(19) United States
(12) Patent Application Publication
(10) Pub. No.: US 2026/0083066 A1
(43) Pub. Date: Mar. 26, 2026

(54) CRANKSHAFT ASSEMBLY FOR HANDHELD POWER TOOLS

(71) Applicant: Milwaukee Electric Tool Corporation, Brookfield, WI (US)

(72) Inventors: Kevin S. Puls, Milwaukee, WI (US); Beth E. Cholst, Wauwatosa, WI (US); Dylan J. Konop, Brookfield, WI (US)

(21) Appl. No.: 19/320,741

(22) Filed: Sep. 5, 2025

Related U.S. Application Data
(60) Provisional application No. 63/698,615, filed on Sep. 25, 2024.

(51) Int. Cl. A01G 3/053; A01G 3/04; F16C 3/06

(52) U.S. Cl. CPC A01G 3/053; F16C 3/06; A01G 2003/0461

(57) ABSTRACT

Crankshaft assemblies for handheld power tools are provided. A crankshaft assembly includes a first engagement member defining a first opening, a second engagement member defining a second opening, a crankshaft coupled to the first engagement member and the second engagement member and configured to rotate about a rotational axis, and at least one crank arm coupled to the crankshaft for driving one or both of the first engagement member and the second engagement member. The crankshaft assembly also includes a first sliding member disposed in the first opening and a second sliding member disposed in the second opening and contacting the first sliding member.

### CROSS-REFERENCE TO RELATED APPLICATIONS

This application claims priority to U.S. Provisional Patent Application No. 63/698,615, filed Sep. 25, 2024, the entire contents of which are incorporated herein by reference.

### FIELD

The present disclosure relates generally to crankshaft mechanisms and handheld power tools, such as hedge trimmer, with crankshaft mechanisms.

### BACKGROUND

Typically, handheld power tools such as hedge trimmers and chainsaws operate using a crankshaft to convert the rotational motion of a small engine into translational motion. These mechanisms allow the handheld power tools to effectively cut through objects or perform other desired tasks. The translational motion may produce undesirable vibrations and sounds. Accordingly, improved crankshaft mechanisms are desired in the art. In particular, crankshafts that reduce vibrations and noise would be advantageous.

### BRIEF DESCRIPTION

Aspects and advantages of the present disclosure will be set forth in part in the following description, or may be obvious from the description, or may be learned through practice of the technology.

In accordance with one embodiment, a crankshaft assembly for a handheld power tool is provided. The crankshaft assembly includes a first engagement member defining a first opening, a second engagement member defining a second opening, a crankshaft coupled to the first engagement member and the second engagement member and configured to rotate about a rotational axis, and at least one crank arm coupled to the crankshaft for driving one or both of the first engagement member and the second engagement member. The crankshaft assembly also includes a first sliding member disposed in the first opening and a second sliding member disposed in the second opening and contacting the first sliding member.

In accordance with another embodiment, a handheld power tool is provided. The handheld power tool includes a first reciprocating element extending between a first end and a second end opposite the first end and a second reciprocating element extending between the first end and the second end. The first end of the first reciprocating element includes a first engagement member defining a first opening and the first end of the second reciprocating element includes a second engagement member defining a second opening. The handheld power tool also includes a motive device and a crankshaft assembly coupling the motive device to the first end of the first reciprocating element and the first end of the second reciprocating element. The crankshaft assembly includes a crankshaft configured to rotate about a rotational axis, at least one crank arm coupled to the crankshaft for driving one or both of the first reciprocating element and the second reciprocating element, a first sliding member disposed in the first opening, and a second sliding member disposed in the second opening and contacting the first sliding member.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a cross-sectional view of a hedge trimmer in accordance with embodiments of the present disclosure;

FIG. 2 is a perspective view of a crankshaft assembly in accordance with embodiments of the present disclosure; and

FIG. 3 is a detailed perspective view of the crankshaft assembly of FIG. 2 in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the terms “integral”, “unitary”, or “monolithic” as used to describe a structure refers to the structure being formed integrally of a continuous material or group of materials with no seams, connections joints, or the like. The integral, unitary structures described herein may be formed through additive manufacturing to have the described structure, or alternatively through a casting process, etc.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, handheld power tools include a crankshaft for translating rotational motion from a motive device, such as an electric motor, into translational motion. The translational motion of may create secondary vibrations and undesirable sounds within the handheld power tool. The translational motion may also create increased stresses exerted on components of the crankshaft. Accordingly, including one or more sliding members in a crankshaft assembly of the handheld power tool may reduce such vibrations, noise, and stresses.

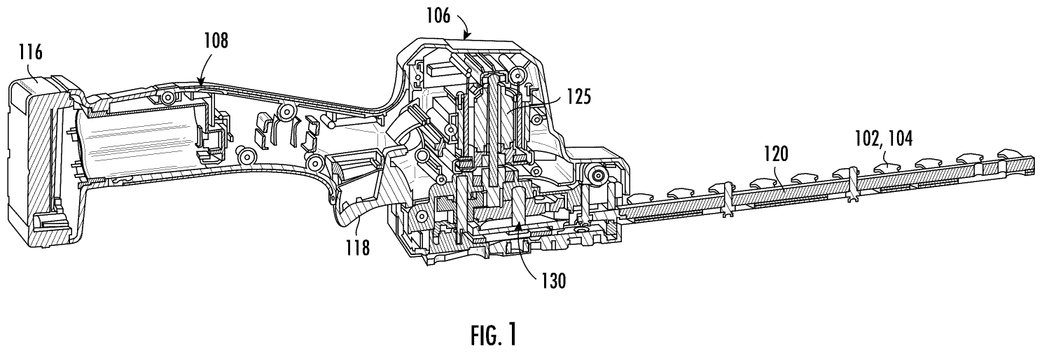

Referring now to the drawings, FIG. 1 illustrates a cross-sectional view of a hedge trimmer 100 in accordance with embodiments of the present disclosure. The hedge trimmer 100 generally includes at least one reciprocating cutting implement. For example, the hedge trimmer 100 may include a first reciprocating element, such as a first blade 102, and a second reciprocating element, such as a second blade 104. The first blade 102 and the second blade 104 include “teeth” which, when the implements are reciprocated, cause the blades to cut into material, such as branches of hedges. For example, the first blade 102 may be a first cutting blade including a first plurality of teeth and the second blade 104 may be a second cutting blade including a second plurality of teeth. In other example embodiments, only one of the first blade 102 and the second blade 104 are configured to reciprocate. For example, one of the first blade 102 and the second blade 104 may remain stationary while the other of the first blade 102 and the second blade 104 reciprocates to cause the blades to cut into the material.

The hedge trimmer 100 may further include a housing 106. The first blade 102 and the second blade 104 may extend from the housing 106. Moreover, the first blade 102 and the second blade 104 of the hedge trimmer 100 may be coupled to a spine 120 extending from the housing 106 for supporting the first blade 102 and the second blade 104. The hedge trimmer 100 may include a handle 108.

As shown in FIG. 1, the hedge trimmer 100 may also include a motive device 125, such as an electric motor or gas powered engine, which drives a crankshaft assembly 130. For example, the motive device 125 may be disposed within the housing 106. The crankshaft assembly 130, as will be discussed in further detail below, may be engaged with the first blade 102 and the second blade 104 such that rotation of a crankshaft of the crankshaft assembly 130 causes the first blade 102 and the second blade 104 to reciprocate. While the crankshaft assembly 130 is discussed with respect to the hedge trimmer 100, it should be understood that the crankshaft assembly 130 may be utilized with other power tools, such as reciprocating saws, oscillating saws (or multi-tools), reciprocating scissors, compressors, dual action sanders, and jig saws.

The motive device 125 may be powered, for example, by a rechargeable energy source such as a battery 116, a fuel source such as gasoline, or the like. In the depicted example embodiment, the hedge trimmer 100 includes an actuator 118. The actuator 118 is disposed proximate to the handle 108. When depressed, the actuator 118 may engage the motive device 125 to cause the first blade 102 and the second blade 104 to move. As the actuator 118 is depressed further, a speed of the motive device can increase from zero speed to a maximum speed. In this regard, the actuator 118 may variably affect the speed of the motive device between a stopped speed, which occurs when the actuator 118 is not depressed, and a maximum speed, which occurs when the actuator 118 is fully depressed.

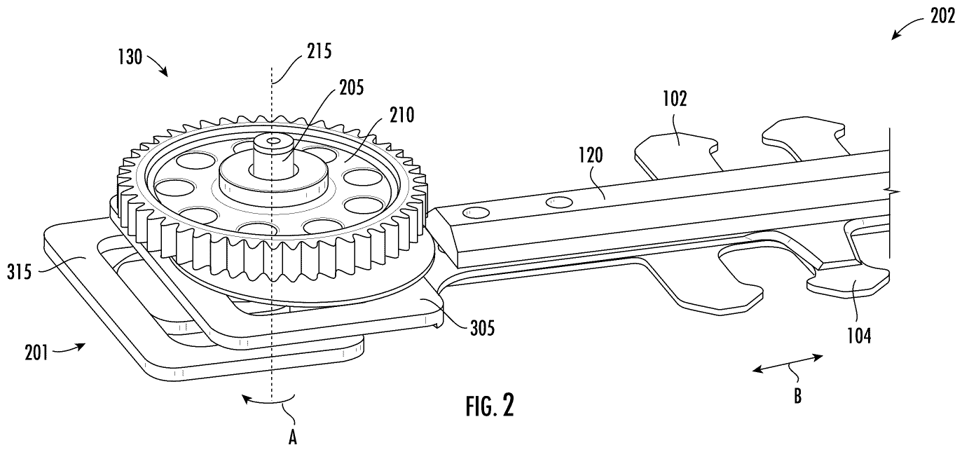

FIG. 2 illustrates a perspective view of the crankshaft assembly 130 of FIG. 1 in accordance with embodiments of the present disclosure.

The first blade 102 and the second blade 104 extend from a first end 201 towards a second end 202 opposite the first end 201. For example, the first end 201 of the first blade 102 and the second blade 104 may be coupled to the crankshaft assembly 130 and be at least partially disposed within the housing 106 (FIG. 1). The crankshaft assembly 130 includes a crankshaft 205 and a gear 210. The gear 210 may be coupled to the motive device 125 and the crankshaft 205 for translating rotational motion from the motive device 125 to the crankshaft 205 such that the gear 210 and the crankshaft 205 rotate about a rotational axis 215. For example, as the crankshaft 205 rotates about the rotational axis 215 in a first direction A, the first blade 102 and the second blade 104 are reciprocated in a second direction B perpendicular to the rotational axis 215. Accordingly, the rotational motion of the crankshaft 205 about the rotational axis 215 in the first direction A is converted to linear motion of the first blade 102 and the second blade 104 in the second direction B.

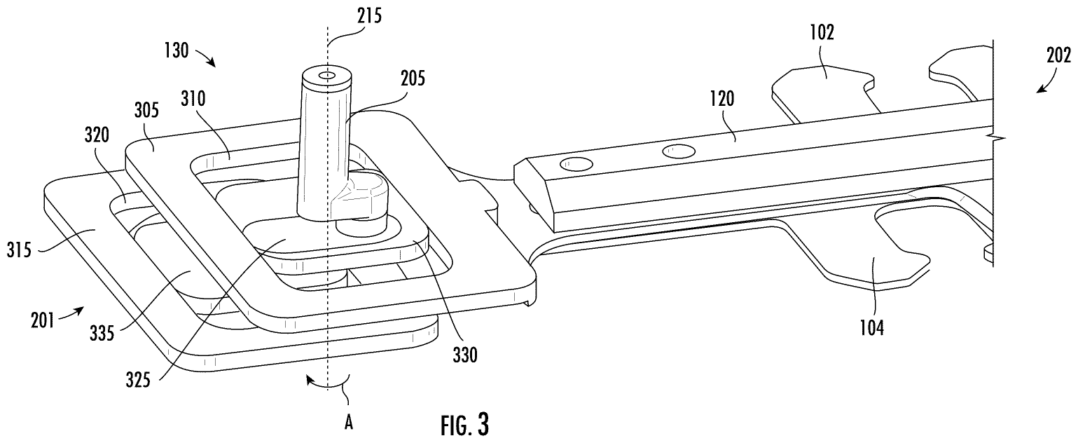

FIG. 3 illustrates a detailed perspective view of the crankshaft assembly 130 of FIG. 2 in accordance with embodiments of the present disclosure. More specifically, FIG. 3 illustrates the crankshaft assembly 130 with the gear 210 removed.

As shown in FIG. 3, the first end 201 of the first blade 102 includes a first engagement member 305 defining a first opening 310 and the first end 201 of the second blade 104 includes a second engagement member 315 defining a second opening 320. In at least one example embodiment, the first opening 310 and the second opening 320 may have a square or rectangular shape. In other example embodiments, the first opening 310 and the second opening 320 may have a round or polygonal shape. The first engagement member 305 may be integral with the first blade 102, and the second engagement member 315 may be integral with the second blade 104. In other example embodiments, the first blade 102 may be coupled to and extend from the first engagement member 305 and the second blade 104 may be coupled to and extend from the second engagement member 315.

The first opening 310 of the first blade 102 and the second opening 320 of the second blade 104 are configured to receive at least a portion of the crankshaft assembly 130. For example, the crankshaft 205 may be disposed within the first opening 310 and the second opening 320. Accordingly, the crankshaft 205 is configured to drive one or both of the first blade 102 and the second blade 104.

Moreover, the crankshaft assembly 130 may include at least one crank arm 325 coupled to and extending from the crankshaft 205. The at least one crank arm 325 may be configured to drive one or both of the first blade 102 and the second blade 104 upon rotation of the crankshaft 205. As shown in FIG. 3, the at least one crank arm 325 may be disposed in the first opening 310 for driving the first blade 102. Additionally, or alternatively, the at least one crank arm 325 may include a first crank arm disposed in the first opening 310 for driving the first blade 102 and a second crank arm disposed in the second opening 320 for driving the second blade 104.

In at least one example embodiment, the crankshaft assembly 130 includes one or more sliding members for reducing vibrations and high contact stresses. For example, the crankshaft assembly 130 may include a first sliding member 330 disposed in the first opening 310 and a second sliding member 335 disposed in the second opening 320. Additionally, the first sliding member 330 may contact at least a portion of the second sliding member 335. Moreover, as shown in FIG. 3, the first sliding member 330 may surround the at least one crank arm 325. Accordingly, the at least one crank arm 325, the first sliding member 330, and the second sliding member 335 convert rotational motion of the crankshaft to reciprocating motion of the first blade 102 and/or the second blade 104. The first sliding member 330 and the second sliding member 335 may have a generally square, rectangular, or any other polygonal shape. A generally square or rectangular shape provides reduced vibrations and less contact stresses with the interior surfaces of the first opening 310 and the second opening 320. In other example embodiments, the first sliding member 330 and the second sliding member 335 may have a round or ovular shape. In still other example embodiments, a plurality of needle bearings may be disposed in one or both of the first sliding member 330 and the second sliding member 335 to reduce sliding friction with the interior surfaces of the first opening 310 and the second opening 320.

The first sliding member 330 and the second sliding member 335 may be formed of a resilient, damping material configured to absorb vibrations and reduce stresses exerted on components of the crankshaft assembly 130. For example, the first sliding member 330 and the second sliding member 335 are configured to contact the interior surfaces of the first opening 310 and the second opening 320 rather than the at least one crank arm 325 of the crankshaft 205 during operation of the crankshaft assembly 130. Moreover, the first sliding member 330 and the second sliding member 335 are configured to slide against each other during rotation of the crankshaft 205. Thus, the first sliding member 330 and the second sliding member 335 move within the first opening 310 and the second opening 320, respectively, as the crankshaft 205 rotates and the first blade 102 and the second blade 104 are reciprocated by the at least one crank arm 325. Accordingly, the first sliding member 330 reduces stresses exerted on an interior surface of the first engagement member 305 defining the first opening 310 and the second sliding member 335 reduce stresses exerted on an interior surface of the second engagement member 315 defining the second opening 320.

Further aspects of the disclosure are provided by one or more of the following embodiments:

A crankshaft assembly for a handheld power tool, the crankshaft assembly comprising: a first engagement member defining a first opening; a second engagement member defining a second opening; a crankshaft coupled to the first engagement member and the second engagement member and configured to rotate about a rotational axis; at least one crank arm coupled to the crankshaft for driving one or both of the first engagement member and the second engagement member; a first sliding member disposed in the first opening; and a second sliding member disposed in the second opening and contacting the first sliding member.

The crankshaft assembly of any one or more of the embodiments, wherein the at least one crank arm is disposed in the first opening and the first sliding member at least partially surrounds the at least one crank arm.

The crankshaft assembly of any one or more of the embodiments, wherein the at least one crank arm, the first sliding member, and the second sliding member are configured to convert rotational motion of the crankshaft about the rotational axis to linear motion of one or both of the first engagement member and the second engagement member.

The crankshaft assembly of any one or more of the embodiments, wherein the at least one crank arm comprises a first crank arm disposed in the first opening and a second crank arm disposed in the second opening.

The crankshaft assembly of any one or more of the embodiments, wherein the first opening and the second opening define a rectangular shape.

The crankshaft assembly of any one or more of the embodiments, wherein: the first sliding member is configured to reduce stresses exerted on an interior surface of the first engagement member defining the first opening; and the second sliding member is configured to reduce stresses exerted on an interior surface of the second engagement member defining the second opening.

The crankshaft assembly of any one or more of the embodiments, further comprising a motive device coupled to the crankshaft for driving rotation of the crankshaft about the rotational axis.

The crankshaft assembly of any one or more of the embodiments, further comprising a first reciprocating element extending from the first engagement member and a second reciprocating element extending from the second engagement member.

The crankshaft assembly of any one or more of the embodiments, wherein the first engagement member is integral with the first reciprocating element and the second engagement member is integral with the second reciprocating element.

The crankshaft assembly of any one or more of the embodiments, wherein: the first reciprocating element comprises a first cutting blade including a first plurality of teeth; and the second reciprocating element comprises a second cutting blade including a second plurality of teeth.

A handheld power tool, comprising: a first reciprocating element extending between a first end and a second end opposite the first end, the first end including a first engagement member defining a first opening; a second reciprocating element extending between the first end and the second end, the first end including a second engagement member defining a second opening; a motive device; and a crankshaft assembly coupling the motive device to the first end of the first reciprocating element and the first end of the second reciprocating element, the crankshaft assembly comprising: a crankshaft configured to rotate about a rotational axis; at least one crank arm coupled to the crankshaft for driving one or both of the first reciprocating element and the second reciprocating element, a first sliding member disposed in the first opening, and a second sliding member disposed in the second opening and contacting the first sliding member.

The handheld power tool of any one or more of the embodiments, wherein the at least one crank arm is disposed in the first opening and the first sliding member at least partially surrounds the at least one crank arm.

The handheld power tool of any one or more of the embodiments, wherein: the motive device drives rotation of the crankshaft about the rotational axis; and the at least one crank arm, the first sliding member, and the second sliding member are configured to convert rotational motion of the crankshaft about the rotational axis to linear motion of one or both of the first reciprocating element and the second reciprocating element.

The handheld power tool of any one or more of the embodiments, wherein the at least one crank arm comprises a first crank arm disposed in the first opening and a second crank arm disposed in the second opening.

The handheld power tool of any one or more of the embodiments, wherein the first opening and the second opening define a rectangular shape.

The handheld power tool of any one or more of the embodiments, wherein: the first sliding member is configured to reduce stresses exerted on an interior surface of the first engagement member defining the first opening; and the second sliding member is configured to reduce stresses exerted on an interior surface of the second engagement member defining the second opening.

The handheld power tool of any one or more of the embodiments, wherein: the first reciprocating element comprises a first cutting blade including a first plurality of teeth; and the second reciprocating element comprises a second cutting blade including a second plurality of teeth.

The handheld power tool of any one or more of the embodiments, wherein the handheld power tool comprises a hedge trimmer.

The handheld power tool of any one or more of the embodiments, wherein the handheld power tool comprises a reciprocating saw, an oscillating saw, reciprocating scissors, a compressor, a dual action sander, or a jig saw.

The handheld power tool of any one or more of the embodiments, wherein the first engagement member is integral with the first reciprocating element and the second engagement member is integral with the second reciprocating element.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A crankshaft assembly for a handheld power tool, the crankshaft assembly comprising:
a first engagement member defining a first opening;
a second engagement member defining a second opening;
a crankshaft coupled to the first engagement member and the second engagement member and configured to rotate about a rotational axis;
at least one crank arm coupled to the crankshaft for driving one or both of the first engagement member and the second engagement member;
a first sliding member disposed in the first opening; and
a second sliding member disposed in the second opening and contacting the first sliding member.

2. The crankshaft assembly of claim 1, wherein the at least one crank arm is disposed in the first opening and the first sliding member at least partially surrounds the at least one crank arm.

3. The crankshaft assembly of claim 1, wherein the at least one crank arm, the first sliding member, and the second sliding member are configured to convert rotational motion of the crankshaft about the rotational axis to linear motion of one or both of the first engagement member and the second engagement member.

4. The crankshaft assembly of claim 1, wherein the at least one crank arm comprises a first crank arm disposed in the first opening and a second crank arm disposed in the second opening.

5. The crankshaft assembly of claim 1, wherein the first opening and the second opening define a rectangular shape.

6. The crankshaft assembly of claim 1, wherein:
the first sliding member is configured to reduce stresses exerted on an interior surface of the first engagement member defining the first opening; and
the second sliding member is configured to reduce stresses exerted on an interior surface of the second engagement member defining the second opening.

7. The crankshaft assembly of claim 1, further comprising a motive device coupled to the crankshaft for driving rotation of the crankshaft about the rotational axis.

8. The crankshaft assembly of claim 1, further comprising a first reciprocating element extending from the first engagement member and a second reciprocating element extending from the second engagement member.

9. The crankshaft assembly of claim 8, wherein the first engagement member is integral with the first reciprocating element and the second engagement member is integral with the second reciprocating element.

10. The crankshaft assembly of claim 8, wherein:
the first reciprocating element comprises a first cutting blade including a first plurality of teeth; and
the second reciprocating element comprises a second cutting blade including a second plurality of teeth.

11. A handheld power tool, comprising:
a first reciprocating element extending between a first end and a second end opposite the first end, the first end including a first engagement member defining a first opening;
a second reciprocating element extending between the first end and the second end, the first end including a second engagement member defining a second opening;
a motive device; and
a crankshaft assembly coupling the motive device to the first end of the first reciprocating element and the first end of the second reciprocating element, the crankshaft assembly comprising:
a crankshaft configured to rotate about a rotational axis,
at least one crank arm coupled to the crankshaft for driving one or both of the first reciprocating element and the second reciprocating element,
a first sliding member disposed in the first opening, and
a second sliding member disposed in the second opening and contacting the first sliding member.

12. The handheld power tool of claim 11, wherein the at least one crank arm is disposed in the first opening and the first sliding member at least partially surrounds the at least one crank arm.

13. The handheld power tool of claim 11, wherein:
the motive device drives rotation of the crankshaft about the rotational axis; and
the at least one crank arm, the first sliding member, and the second sliding member are configured to convert rotational motion of the crankshaft about the rotational axis to linear motion of one or both of the first reciprocating element and the second reciprocating element.

14. The handheld power tool of claim 11, wherein the at least one crank arm comprises a first crank arm disposed in the first opening and a second crank arm disposed in the second opening.

15. The handheld power tool of claim 11, wherein the first opening and the second opening define a rectangular shape.

16. The handheld power tool of claim 11, wherein:
the first sliding member is configured to reduce stresses exerted on an interior surface of the first engagement member defining the first opening; and
the second sliding member is configured to reduce stresses exerted on an interior surface of the second engagement member defining the second opening.

17. The handheld power tool of claim 11, wherein:
the first reciprocating element comprises a first cutting blade including a first plurality of teeth; and
the second reciprocating element comprises a second cutting blade including a second plurality of teeth.

18. The handheld power tool of claim 11, wherein the handheld power tool comprises a hedge trimmer.

19. The handheld power tool of claim 11, wherein the handheld power tool comprises a reciprocating saw, an oscillating saw, reciprocating scissors, a compressor, a dual action sander, or a jig saw.

20. The handheld power tool of claim 11, wherein the first engagement member is integral with the first reciprocating element and the second engagement member is integral with the second reciprocating element.
